(19) United States
(12) Patent Application Publication
(10) Pub. No.: US 2026/0050144 A1
(43) Pub. Date: Feb. 19, 2026

(54) INFINITY CORRECTED PHOTOGRAPHIC AND CINEMATOGRAPHIC LENS SYSTEM

(71) Applicant: H. Jay Margolis, Centennial, CO (US)

(72) Inventor: H. Jay Margolis, Centennial, CO (US)

(21) Appl. No.: 19/101,551

(22) PCT Filed: Aug. 4, 2023
(86) PCT No.: PCT/US2023/071734

§ 371 Date: Feb. 5, 2025

Related U.S. Application Data
(60) Provisional application No. 63/397,527, filed on Aug. 12, 2022.

(51) Int. Cl. G02B 13/00; G02B 7/02; G02B 7/14

(52) U.S. Cl. CPC G02B 13/009; G02B 7/021; G02B 7/14; G02B 13/0015

(57) ABSTRACT

The present invention generally relates to optical imaging systems able to form an infinity corrected beam from light received from a front lens system, thereby standardizing the working distance of any front lens system able to be integrated with the present invention. This allows a wide variety of front objectives to be used interchangeably with photographic and motion-picture cameras and other optical instruments, and also allows front objective lens systems to be miniaturized or otherwise modified.

### CROSS-REFERENCE TO RELATED APPLICATIONS

This application claims priority from U.S. Provisional Patent Application No. 63/397,527, filed Aug. 12, 2022, which is incorporated by reference herein to the extent that there is no inconsistency with the present disclosure.

### BACKGROUND OF THE INVENTION

The present invention relates to optical imaging systems able to form an infinity corrected beam from light received from a front lens system, thereby standardizing the working distance of any front lens system able to be integrated with the present invention. This allows a wide variety of front objectives to be used interchangeably with photographic and motion-picture cameras and other optical instruments, and further allows front objective lens systems to be miniaturized or otherwise modified.

Many conventional optical systems attempt to use relays or other types of optical fixes behind the objective lens to improve image quality or to increase the depth of field. However, such systems are generally impractical due to size, provide insufficient depth of field, or degrade the image quality in one or more areas.

U.S. Pat. No. 5,054,896 (Margolis) discloses a continuously-focusable microscope, which incorporates a relay based on the unique characteristics of afocal variation as a focusing means that can be focused to infinity. U.S. Pat. No. 10,935,753 (also to Margolis) discloses a photographic and cinematographic lens system able to provide increased depth of field while maintaining wide field of view. Additional optical systems are available to provide similar effects and images, but such additional systems are typically relatively long and cumbersome and also do not provide imagery similar in quality as provided by the present invention. Such additional systems also are not typically compatible with a wide variety of front objectives systems and configurations.

Accordingly, what is needed is an imaging device which is able to provide increased image quality, including but not limited to wider coverage, and allows a wide variety of front objective lens systems to be miniaturized or otherwise modified while still being suitable for use with different formats and high quality sensors, cameras, and recording devices, such as those used for motion picture and scientific photography and imaging.

### SUMMARY OF THE INVENTION

In view of the foregoing, aspects of the present invention provide optical imaging systems having a rear focusing system able to form an infinity corrected beam from light received from a front lens system. The infinity corrected beam is able to be relayed to a rear imaging system, which can be used to control the magnification, field coverage, and other aspects of the collected images. This allows a wide variety of front objectives to be used interchangeably with photographic and motion-picture cameras and other optical instruments having different formats, and also allows front objective lens systems to be miniaturized or otherwise modified while still generating suitable image quality.

In a first embodiment of the present invention, a known objective lens type is miniaturized (i.e., made according to a smaller scale) to produce an aerial image, from which the rear focusing systems provides an infinity beam to a rear imaging system. The rear imaging system is optionally positioned at a rear conjugate equal to or approximate to its focal length. The rear imaging system may also magnify the image to fit the desired format without a loss of image quality. For example, Tessar or Sonnar type lenses could be appropriately miniaturized, thereby resulting in simplified and less expensive systems, to provide a suitably-sized aerial image. Alternatively, eyepiece designs of all types, limited only by compatibility, are also able to be utilized.

In a second embodiment, the present invention incorporates a minifying lens with a front objective lens system, where the minifying lens is able to effectively reduce the rear focal length of the front objective lens system. The resulting aerial image is formed closer to the objective lens system and will also be a smaller image. However, as described above, the rear focusing systems provides an infinity beam from the aerial image to a rear imaging system, which is able to magnify the image. In such a way, almost any objective lens can be combined with a minifying lens and utilized with the present invention, limited only by compatibility and suitability.

As a result of the rear focusing system being able to generate an infinity beam from the aerial image, rear imaging lenses of any known type can be used as infinity tube lenses (as known in microscopy) to allow field coverage of various sensor or recording formats. Thus, a series of different focal length lenses can be interchanged with one another, yet the characteristics of the entire optical system would essentially remain unaffected except as to the chosen sensor or recording medium coverage. In this way when suitably used in housings of various lengths, a series of infinity tube lenses could be freely exchanged with one another to cover various formats and projective-derived magnification factors.

For example, in an embodiment, the front working distance would not significantly change upon use of one focal length rear infinity-set lens or another. However, due to the intended projection of the image, the final magnification could be increased or decreased as needed.

Because the lenses would be used in an infinity beam, various additional optical components such as Galilean telescopes, magnification changers, zoom systems, etc., known to be particularly used in microscopical practice, can now be utilized in systems designed primarily for use in photography, cinematography or other imaging requirements not typically used for microscopy.

In a third embodiment, the distance between the front objective and the rear focusing system is extended by putting the formation of the aerial image not at its original front focus, but where the front objective is set to provide an infinity beam. A tube lens of short focal length produces a focus to the formed aerial image which is then acted upon as if it were a normal position. With this configuration, the front objective lens is effectively modified to form a functional extension tube or proboscis.

The resulting optical imaging systems are also able to minimize the effects chromatic and spherical aberration and/or the effects of dust, contaminates, or small particles.

In an embodiment, the present invention provides an optical imaging system comprising: a) an optical housing able to hold one or more optical lens systems, the optical housing having a front end able to receive light from an object and having a back end; b) a front objective lens system positioned within the optical housing able to form an aerial image of the object; and c) a rear focusing system positioned behind the front objective lens system, wherein the rear focusing system has a focal length and is positioned within the optical housing so as to be able to focus the aerial image and transmit an infinity beam to a rear imaging system. In a further embodiment, the optical imaging system further comprises the rear imaging system positioned within the optical housing behind the rear focusing system, wherein the rear imaging system is able to focus and optionally provide magnification to the infinity beam.

Optionally, the imaging system further comprises a minifying lens system positioned between the front objective lens system and the rear focusing system. The minifying lens system may be any lens system known in the art able to effectively reduce the back focal length of the front objective lens system, including but not limited to a compressor lens system, Fresnel lens system, achromat lens system, or focal reducer lens system. As a result of the minifying lens system, the aerial image is modified and is formed closer to the front end of the optical housing. Preferably, the image is also smaller and brighter. As long as the rear focusing system is positioned to focus the aerial image in its altered position and transmit an infinity beam, the aerial image is able to be relayed to the rear imaging system, which may magnify and otherwise modify the image. In an embodiment, by modifying and relaying the aerial image in this manner, the optical imaging system provides increased imaging coverage of the object and/or is able to adjust the image to fit on different sensor sizes and formats. Additionally, portions of the optical system may be made shorter or smaller, if necessary or desirable. Optionally, the minifying lens may be moveable or deformable in order to adjust the modified aerial image.

If the compression of an image or light (e.g., images generated by very fast, large aperture lenses) were to result in the generation of heat, it may be desirable to appropriately include neutral density filters, heat absorbing glasses or other known means of heat dissipation to embodiments of the invention.

In an embodiment, it may be desirable to use a smaller version or miniaturized configuration of a specific front objective lens system rather than use a minifying lens to reduce or compress the aerial image. Such a configuration should be simpler and proportionately less expensive to produce, since the reduced size of the components also reduce many of the traditional requirements for aberrational correction, centration, critical spacing, and materials. However, using a smaller configuration would produce a smaller image when focused on the camera sensor or recording format. Traditional methods for enlarging the image size typically result in image distortion or loss of image quality. Because the rear focusing system is able to form an infinity corrected beam from the front objective system, embodiments of the present invention permit the use of a smaller version of the front objective system and subsequent enlargement of the image without loss of image quality. Accordingly, virtually any lens configuration (e.g., a miniaturized anamorphic lens system) can be utilized in smaller form and the image characteristics can be maintained.

As used with the optical systems described herein, virtually all lens types, limited only by suitability and compatibility, can be miniaturized (i.e., their aerial images reduced in size by using a minifying lens or a smaller version of the front objective lens system is used) and then the image magnified by the rear imaging systems for use. With an infinity beam exiting the rear focusing system, different interfaces and optical components can also be introduced into the camera or optical system, including but not limited to zoom lenses, anamorphic lenses, Galilean telescopes for magnification change, reticule systems, and illumination devices. In an embodiment, zoom lenses and anamorphic lenses, in fact, most all types of lenses used in cinematography and photography applications can be made small to have their images magnified to fill suitable formats.

In an embodiment, the front objective lens system comprises a first positive lens system and a first negative lens system. Optionally, the front objective lens system comprises one or more additional lenses. For example, the front objective lens system may comprise a three-lens objective. In an embodiment, the front objective lens system comprises a front lens system having a focal length of 30 mm (±10% or ±5%), a middle lens system having a focal length of 100 mm (±10% or ±5%), and a rear lens system having a focal length of 40 mm (±10% or ±5%).

In an alternative embodiment, the front objective lens system comprises a front lens system having a focal length of 30 mm (±10% or ±5%), a middle lens system having a focal length of 15 mm (±10% or ±5%), and a rear lens system having a focal length of 30 mm (±10% or ±5%). In an alternative embodiment, the front objective lens system comprises a front lens system having a focal length of 40 mm (±10% or ±5%), a middle lens system having a focal length of 20 mm (±10% or ±5%), and a rear lens system having a focal length of 40 mm (±10% or ±5%).

Optionally, one or more lenses of the objective lens systems are derived from an eyepiece type configuration and/or comprise achromatic lenses or planocovex lenses. In embodiments, the front objective lens system has a front surface which is curved toward the front end of the housing. Alternatively, the front objective lens system has a flat surface which faces the front end of the housing, or has a front surface which is curved toward the rear end of the housing. In embodiments, the objective lens system is a modified Erfle lens system, modified Konig lens system, or modified Nagler lens system.

In an embodiment, the rear focusing system is any lens or series of lenses able to focus the aerial image and transmit an infinity beam to a rear imaging system (such as the imaging system of a camera, sensor, microscope and other optical devices). Preferably, the rear focusing system is able to move or deform one or more lens elements in order to adjust the focus of the rear focusing system on the aerial image. This can be done so that the rear focusing system is compatible with multiple different front objective lens systems, formats, cameras, and other optical devices. In alternative embodiments, the rear focusing system provides a fixed focal length.

The rear focusing system can be used with different front objective lens systems, or front objective lens systems modified with a minifying lens system, allowing the front objective lens systems to be interchanged, modified, or the rear focusing system to be provided as a modular component. Additionally, the rear focusing system can be used with different rear imaging systems, which are able to provide different magnifications and working distances.

The rear imaging systems having different focal lengths may be used depending on the desired effect of the device (i.e., altered magnification or field of view). Moreover, the rear imaging system is capable of being spaced within the optical system so as not only to provide focus, but to allow the interfacing of various components such as prism and lensed erecting systems, filters, zoom systems and the like as are known in the art.

In any embodiment described herein, distances between lenses of the optical imaging system can be positioned and/or adjusted to provide an image as is known in the art. Additionally, one or more lenses of the optical imaging system are moveable, deformable, or are able to vibrate so as to focus the image or otherwise provide the desired image.

In an embodiment, the optical imaging system further comprises a frontal corrector lens system positioned within the optical housing in front of the front objective lens system. Preferably, the frontal corrector lens is able to decrease system distortion by c.5% or more, preferably by c.10% or more, or by at least approximately c.12%, than if the corrector lens were not employed. In an embodiment, the frontal corrector lens system has a focal length of approximately 100 mm or more, 300 mm or more, 500 mm or more, or 700 mm or more. In an embodiment, the frontal corrector lens system has a focal length between 400 mm to 1000 mm, or between 500 mm to 750 mm. In an embodiment, the frontal corrector lens system has a focal length of approximately 750 mm. Preferably, the frontal corrector is an achromatic lens. The frontal corrector can have a flat front surface, a front surface which curves toward the front end of the housing, or a front surface which curves toward the rear end of the housing.

In an embodiment, the present invention provides a modular optical imaging system able to be attached to different systems having front objectives able to form an aerial image. The modular optical imaging system comprises: a) an optical housing able to hold one or more optical lens systems, the optical housing having a front end able to attach to a front lens system having a front objective lens system, wherein the front objective lens system is able to form an aerial image of an object; and b) a rear focusing system positioned within the optical housing, wherein the rear focusing system has a focal length so as to be able to focus the aerial image and transmit an infinity beam to a rear imaging system. In a further embodiment, the modular imaging system further comprises the rear imaging system positioned within the optical housing behind the rear focusing system, wherein the rear imaging system is able to focus and optionally provide magnification to the infinity beam.

Preferably, the modular imaging system further comprises a minifying lens system positioned in front of the rear focusing system. The minifying lens system is able to produce a modified aerial image in conjunction with the front objective lens system, where the modified aerial image is formed closer to the front end than the aerial image formed when the minifying lens is not used. In an embodiment, the minifying lens system may be any lens system known in the art able to effectively reduce the back focal length of a front objective lens system when the modular imaging system is attached and form the aerial image. Suitable minifying lens systems include, but are not limited to a compressor lens system, Fresnel lens system, achromat lens system, or focal reducer lens system.

In an embodiment, when the modular optical imaging system is attached to the front lens system, the minifying lens modifies the back focal length of the front objective lens system so that the resulting aerial image is formed closer to the front objective lens system. Preferably, the image is also smaller and brighter. The resulting image can then be magnified and relayed by the rear focusing system and rear imaging system so as to increase the field coverage, fit the image to a desired sensor or camera format, and/or impart any and all other desirable characteristics that the use of such a magnifying relay imparts. For example the modular optical imaging system can be attached to a pre-existing front objective lens system and used to provide deep focus or forced perspective techniques commonly desired in cinematography, photography and other imaging disciplines. Optionally, the minifying lens may be moveable or deformable in order to adjust the modified aerial image

In an embodiment, the magnification and working distance of the rear imaging system is selected to provide a desired modification of the image provided by the front objective lens system. For instance, the rear imaging system can be selected to provide a magnification that allows the objective lens system to be miniaturized while still providing a suitable projection to sensor or recording format.

In general, commercial lenses used in cinematography and/or photography have commonly defined back focal lengths. The modular optical system of the present invention has sufficient rear projective length, such that by appropriate spacing most if not all formats commonly used in those disciplines can be accommodated.

In an embodiment, the modular optical imaging system is able to be attached to front objective lens system having a first positive lens system and a first negative lens system, where the rear focusing system comprises a second positive lens system, a third positive lens system, and a second negative lens system. Optionally, the first negative lens system and second positive lens system have a combined focal length 20% to 30% greater than a focal length of the first positive lens system, the second negative lens system has a focal length within 10% of the combined focal length of the first negative lens system and second positive lens system, the third negative lens system has a focal length that is within 590% and 610% of the combined focal length of the first negative lens system and second positive lens system, and the second positive lens system is positioned behind the first negative lens system at a distance between 65% to 85% of a focal length of the first negative lens system.

In embodiments described herein, an anamorphic lens element or elements are incorporated in the front objective lens system and/or the rear focusing system to incorporate such imaging characteristics, all the while retaining all other characteristics detailed herein. The anamorphic elements can be utilized individually in either the front objective lens system or rear focusing system, or simultaneously in both. The anamorphic elements can also be removed from either or both front and rear systems and, as to need an suitability, non-anamorphic elements can be their replacements, thereby turning the entire to be non-anamorphic. Thus, the present invention permits the anamorphic elements to be modular which can be introduced or removed as desired.

Preferably, the optical imaging systems and modular optical imaging systems described herein are able to be integrated with any standard format, including but not limited to 23 mm cameras, 24 mm cameras, 35 mm cameras, and cinematographic cameras. In embodiments of the invention, the optical imaging system is compatible with current motion picture and photographic cameras, including, but not limited to, 23 mm, 24 mm, 35 mm, 70 mm, and 8×10 inch camera formats, and digital cameras and other devices having sensor sizes including, but not limited to, 36 mm×24 mm, APS-H 27.9 mm×18.6 mm, APS-C 23.6 mm×15.6 mm, 22.2 mm×14.8 mm, 18.7 mm×1 mm, and MFT 4/3 inches, and one inch (12.8mm×9.6 mm).

Preferably, the optical imaging devices described herein are compact to allow for easier use and integration with existing cameras and other optical devices. In an embodiment, the optical housing has a length of approximately 400 mm or less, 300 mm or less, or 200 mm or less.

In embodiments, the present invention provides a compact and easy to use optical device which allows a user to quickly take high quality still photographs, videos, and/or cinematographic images, where the majority of objects beyond a certain distance will automatically be in focus.

In the embodiments described herein, focal lengths and distances are typically provided in millimeters (mm). Such values are understood to encompass focal lengths and distances that are equal to the given value in mm, preferably ±1% of the given value, preferably ±2% of the given value, preferably ±5% of the given value, or preferably that are ±10% of the given value.

By setting the spatial relationship of the objective lens systems described herein to the movement of a focusing lens system, when an object is imaged at a distance of infinity, dust, small particles, or other contaminants will not be imaged simultaneously at any focus there or when refocused to provide an image at its closest distance. Consequently, dust, small particles, or other contaminants are virtually unable to be noticed or imaged by the present invention when, at the same time, a usable image is provided.

### BRIEF DESCRIPTION OF THE DRAWINGS

The accompanying drawings illustrate or describe various aspects and embodiments of the present invention:

FIG. 1, panel a), illustrates an optical imaging system in an embodiment of the present invention comprising a front objective lens system able to form an aerial image, a rear focusing system able to generate an infinity beam from the aerial image, and a rear imaging system able to focus the resulting image onto a sensor. Panel b) illustrates a similar optical imaging system further having a minifying lens system that reduces the back focal length of the front objective lens system and alters the position of the formed aerial image.

FIG. 2 shows multiple optical imaging systems (rear imaging system not shown) containing minifying lens systems in an embodiment of the present invention, where the front objective lens system in one embodiment is comprised of different lens configurations, and where the second negative lens system is able to be positioned at different distances in order to adjust the focal length of the rear focusing system.

FIG. 3 shows an optical imaging system (rear imaging system not shown) similar to those shown in FIG. 2, but where the front objective lens system contains a more complex exemplary lens configuration.

FIG. 4 shows a modular optical imaging system in an embodiment of the present invention comprising a rear focusing system and rear imaging system. The modular optical imaging system is able to attach to a variety of different front objective lens systems, such as to form the optical imaging system of FIG. 1, panel a).

FIG. 5 shows a similar modular optical imaging system in an embodiment of the present invention comprising a minifying lens system along with the rear focusing system and rear imaging system. The modular optical imaging system is able to attach to a variety of different front objective lens systems, such as to form the optical imaging system of FIG. 1, panel b).

FIG. 6 shows multiple rear imaging systems, such as used in FIGS. 1, 4 and 5, having different format coverages. Using different rear imaging systems will result in a different working distance of the optical imaging system.

FIG. 7 shows an example of a compressor lens (right most lens) being used with a 100-mm focal length Tessar lens with a 4-Deg. half FOV (three lenses on the left).

### DETAILED DESCRIPTION OF THE INVENTION

### Definitions

The terms and definitions contained herein are used according to their normal definitions as understood in the art. The following definitions are provided to add further clarification to the terms.

As used herein, an “aerial image” is a projected image which is formed in free space, such as within the optical housing of an optical system or device, and can be viewed when focused by another lens. Because a screen is not used to diffusely reflect the image, the aerial image can only be observed from a position behind the image plane and along the principal axis of the lens.

As used herein, the term “infinity beam” refers to rays of light traveling in a parallel, or essentially parallel, path. For example, in an embodiment, an “infinity beam” includes rays of light, or other types of electromagnetic radiation, travelling in a path which does not deviate by more than 5%, preferably no more than 1%, even more preferably no more than 0.1% from parallel.

As used herein, “format” refers to the size and shape of film, a camera sensor, or an image sensor for an optical device, able to receive and/or record an image.

“Field of view” refers to the part of an object or scene that is projected onto the camera sensor or film by an optical system. Objects outside the field of view when the picture is taken are not recorded or displayed in the final image or photograph. “Field of view”is often expressed as the angular size of the view cone, such as the term “angular field of view”. In contrast, “depth of field” refers to the distance between the closest and furthest points in an image that are in acceptable focus.

As used herein, the term “lens system” can refer to a single lens or lens element, or to multiple lenses and lens elements, such as doublets or triplets, as known in the art. For example, the lens systems described herein can each comprise a single lens or multiple lenses, such as doublets or triplets, as known in the art. In a further embodiment, the microscopes, cameras and devices used with the optical imaging device further comprises one or more additional optical components, including but not limited to eye pieces, sensors, cameras, corrective lens systems, beam splitters, polarizers, prisms, illuminators and combinations thereof, to modify and produce the final image or images. The additional optical components may be used in conjunction with the objective lens system, or placed along the optical path.

“Focal length” is the distance between the center of a lens or optical system and its focal point. As used herein, the “back focal length” refers the distance between the center of a lens or optical system and the image plane where an aerial image is formed. “Focal plane” refers to the imaginary line perpendicular to the optical axis which passes through a lens's or optical system's focal point.

“Spherical aberration” is the lens aberration resulting from the increased refraction of light rays passing through or near the edge of the lens compared to light rays passing through or near the center of the lens. Light rays across different regions of the lens are focused at different points resulting in an imaging having increased blur.

“Chromatic aberration” is the lens aberration resulting from the normal increase in refractive index of all common materials toward the blue end of the spectrum. The change in image size from one color to another is known at lateral chromatic difference of magnification.

As used herein, “infinity focus”, “set to infinity” or being able to form a “focus to infinity” is the state where a lens or other optical system is able to form an image of an object an infinite distance away. Infinity focus places the plane of focus at a sufficiently far distance that light from than plane reaching the lens are essentially parallel.

### Overview

In general, the present invention utilizes unique spatial and optical relationships to provide simple and compact optical imaging systems and devices, which are able to form an infinity corrected beam from light or images received from a front objective lens system, thereby standardizing the working distance of any front lens system able to be integrated with the present invention. That is, each front objective can have its own operative working distance, but because an infinity beam is generated from the front objective, a wider range of rear imaging systems having different magnifications and format coverages can be used in conjunction with the front objective. Thus, in certain aspects of the invention, the working distance for each front objective can be treated as a common standard regardless of the optical components used in front of the infinity beam.

As an additional result, the rear imaging system can be selected to provide both the desired magnification and field coverage, allowing different sensor sizes to be selected, one format to be quickly changed to another, magnification to be changed, and/or to allow downstream components and sensor formats to be quickly and easily switched.

Additionally, since different magnification can be selected for these systems by selecting different rear imaging systems regardless of the front objective, the present invention allows the miniaturization of any known front lens type that is able to be used with the imaging system. In other words, if the optical imaging system is able to generate a suitable aerial image from a miniaturized front objective, then different rear imaging systems can be selected to magnify a suitable projection onto suitable sensor or recording formats without significant loss of image quality.

Varying front objective lenses have often been used on turrets before, where the turret allows for an easy switch to a different object lens having a different magnification. However, such turrets are large and cumbersome and are generally not practical for use with standard photographic and cinematographic cameras. With the present invention, it is possible that anamorphic lenses used as part of the rear imaging system can be quickly switched with a zoom lens or standard lens type in a far more compact and easy to use design. For example, with common cinematography lenses, a kit or package can be provided having different interchangeable lens types that can be quickly and easily integrated into the rear imaging system to provide different desired effects.

These lenses could be different proprietary lenses or commonly available lenses regardless of the lens type, gearing, motor activation and other accessories. For example, a gearing could be used to turn all lenses, engaging each on a turret as positioned in turn.

This means that this system facilitates the greater effectiveness of cine or photo production, lowers the weight and bulk of portage, taking the place of many lenses needed, but in a more convenient way.

### EXAMPLES

### Example 1

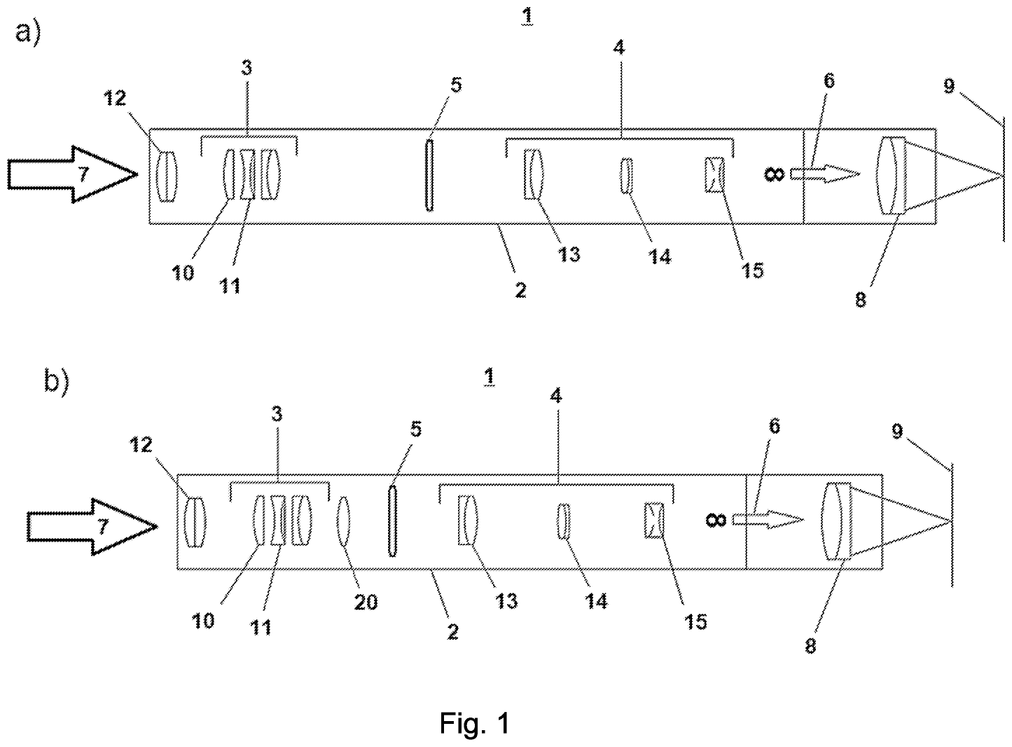

FIG. 1, panel a), illustrates a simplified optical imaging system 1 in an embodiment of the present invention comprising an optical housing 2 which contains a frontal corrector lens system 12 and a front objective lens system 3 in optical communication with a rear focusing system 4 and a rear imaging system 8. Light rays 7 enter the front of the optical imaging system 1 (the left side as depicted in the figures) and are transmitted through the front objective lens system 3, which forms an aerial image 5. While embodiments illustrated in the present figures depict exemplary lens configurations, it should be noted that the number, configuration, and types of lenses in each component can vary in order to adjust one or more parameters of the imaging system 1.

The rear focusing system 4 is able to focus on the aerial image 5 and generate an infinity beam 6, which is transmitted to a rear imaging system 8. The rear imaging system 8 is able to focus the infinity beam 6 onto a sensor (or film) 9 which can be part of a standard camera, sensor, or other optical device.

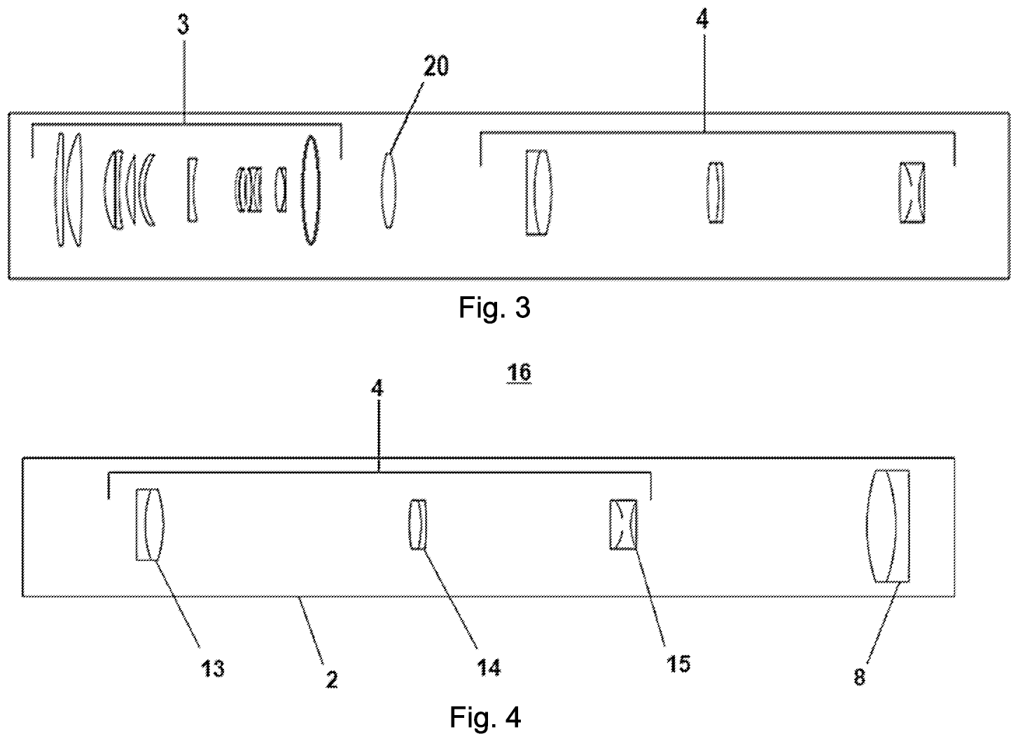

As seen in FIGS. 1-3, the front objective lens system 3 may comprise multiple different lenses, including a first positive lens system 10 and first negative lens system 11, as well as other additional lenses to form a functional objective. Depending on the working distance of the front objective lens system 3, the resulting aerial image 5 will be generated at different distances within the optical housing 2.

Additionally, a minifying lens system 20 (see FIG. 1, panel b)), may be positioned between the front objective lens system 3 and the rear focusing system 4. When used in conjunction with the front objective lens system 3, the minifying lens system 20 forms the aerial image 5 closer to the front objective lens system 3. The aerial image 5 will likely be smaller than any corresponding aerial image formed without the minifying lens (FIG. 1, panel a)). As a result, the imaging system 1 may be smaller and more compact. Because the rear focusing system 4 is able to produce an infinity beam 6, the rear imaging system 8 may be selected as to provide increased magnification and to provide an image size that fits the desired sensor size. As an additional benefit, the resulting final image may also have increased field of view.

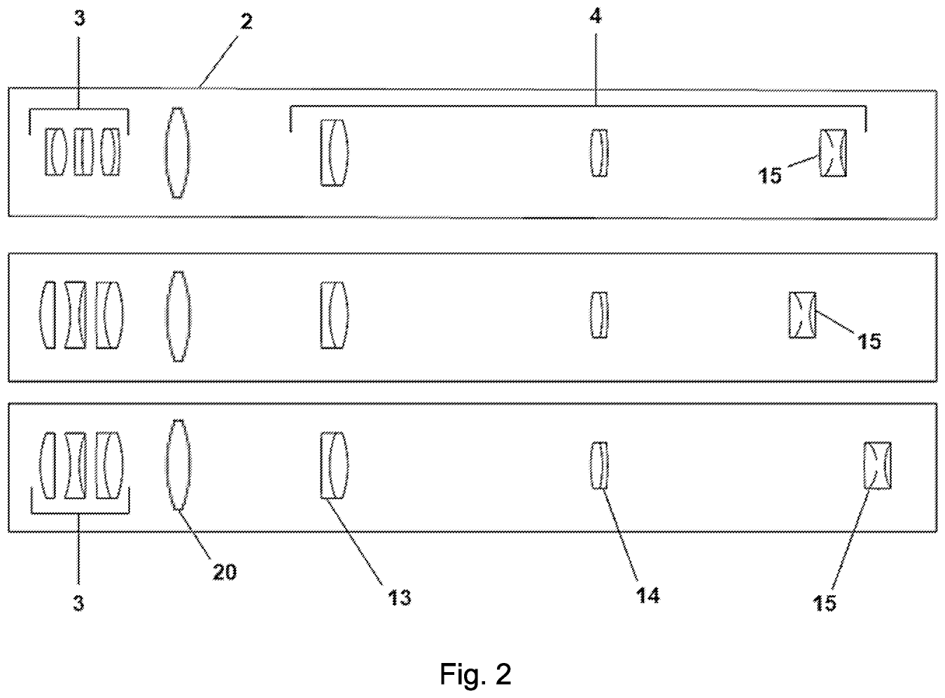

As seen in FIGS. 1-5, the rear focusing system comprises a second positive lens system 13, a third positive lens system 14, and a second negative lens system 15. The second negative lens system 15 is moveable (see FIG. 2) and is able to be positioned at different distances in order to adjust the focal length of the rear focusing system 4. This alters the front working distance of the rear focusing system 4 and enables the rear focusing system 4 to focus on the aerial image 5 at different distances and produce the infinity beam 6.

FIG. 4 shows a modular optical imaging system 16 in an embodiment of the present invention comprising a rear focusing system 4 and rear imaging system 8. The modular optical imaging system 16 is able to attach to a variety of different front objective lens systems 3, such as to form the optical imaging system illustrated in FIG. 1, panel a).

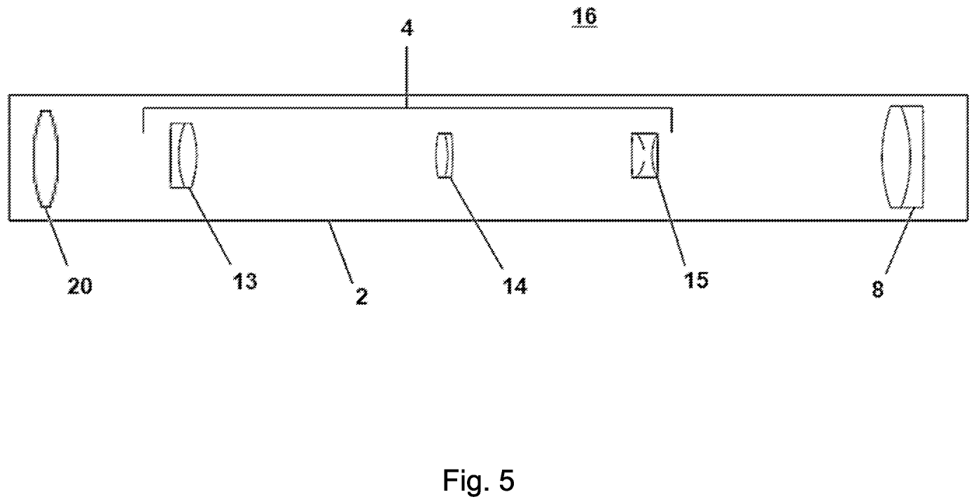

FIG. 5 shows an additional modular optical imaging system 16 in an embodiment of the present invention comprising a rear focusing system 4, rear imaging system 8, and a minifying lens 20. This modular optical imaging system 16 is also able to attach to a variety of different front objective lens systems 3 to miniaturize the overall system, such as to form the optical imaging system illustrated in FIG. 1, panel b), or to improve one or more characteristics of the final image.

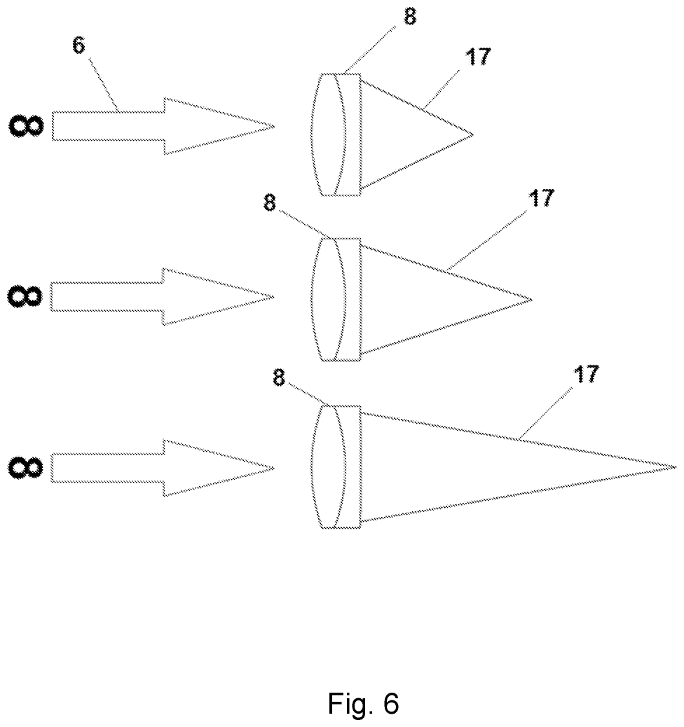

The rear focusing system 8 can be any lens system able form an image when used in conjunction with the rest of the imaging system and includes fixed focal length lens systems as well as lens systems which provide adjustable focus (not shown). FIG. 6 shows multiple rear imaging systems 8, such as used in FIG. 1 and that can be used with the modular optical imaging systems of FIGS. 4 and 5, having different focal lengths 17. For example, one rear imaging system 8 may be a standard lens, while a different rear imaging system may be a zoom lens. Thus, using different rear imaging systems 8 in the optical imaging system 1 or modular imaging system 16 will result in a different projection distance as well as different characteristics, such as magnification. Accordingly, switching modular optical imaging systems 16 having rear imaging systems 8 with different focal lengths 17 will produce different effects, such as magnification, when attached to front objective system 3.

In one aspect, the optical imaging systems of the present invention are useful in that they can be attached or integrated with pre-existing cameras and optical devices. Different frontal objectives 3, including objectives used in conjunction with a minifying lens 20, can be used with pre-existing sensors or camera provided that the rear focusing system 4 is able to generate a suitable infinity beam 6 from the objective lens system 3. The imaging systems may optionally contain additional optical components, including but not limited to apertures, reticules, gratings, irises, and diaphragms, to control the amount of light through the system, create optical effects, and to limit optical aberrations (such as spherical and chromatic aberration) as known in the art.

### Example 2—Efficacy of a Rear Focusing Lens and Compression Lens

An achromat or achromatic asphere lens was tested for use as a rear refocusing lens, and it was determined that the lens can be used for focusing on infinite conjugate onto a format size between 1/2.5″ and full frame. When used in conjunction with a TS-160 (Infinity Photo-Optical Company) where the refocusing lens is between the TS-160 and the camera, the aerial focus will move to provide the infinity focused image to the refocusing lens. Additionally, a varifocal or zoom lens can be used as a rear refocusing system to change the focal length and accommodate different format sizes.

Additionally, a 20-mm achromat was used as a compressor (minifying) lens in between the flange distance of the camera or objective lens and the sensor to reduce the distance to the aerial image and to reduce the image height of the aerial image to a size that matches the desired format.

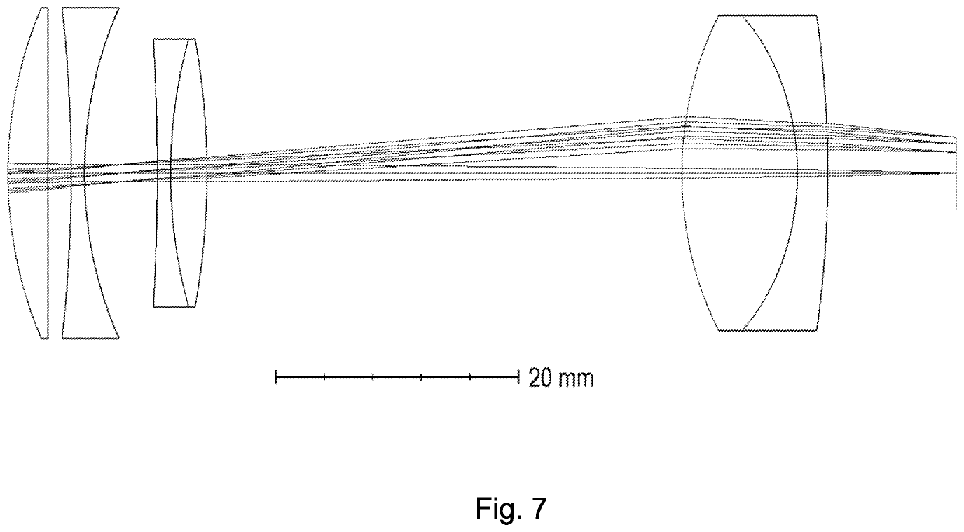

More specifically, a positive lens placed between a front objective and its image plane will contract or compress the image size. FIG. 7 shows a layout with a 100-mm focal length Tessar lens being used with a 4 degree half field-of-view. The compressor lens on the right is an achromat of 20 mm focal length. The aerial image height shown is 2.278 mm. Smaller image sizes can be obtained with shorter focal length compressor lenses or by reducing the FOV. Pupil matching can be accomplished by known methods in the field, e.g., stop shifting, field lenses, balancing the power and position of the compressor lens relative to the objective.

The compressor lens illustrated in FIG. 7 fits within 52 mm of the uncompressed focus to ensure that it is able to be mountable to existing lenses and lens formats.

Although the embodiments exemplified herein are generally simple and economical to make, it is also understood that additional complex systems and devices can be constructed in accordance with the present invention. For example, lens systems can, in some cases, be substituted with deformable lenses, refractive and/or defractive lenses, and lenses with different gradients.

Having now fully described the present invention in some detail by way of illustration and examples for purposes of clarity of understanding, it will be obvious to one of ordinary skill in the art that the same can be performed by modifying or changing the invention within a wide and equivalent range of conditions, formulations and other parameters without resort to undue experimentation without affecting the scope of the invention or any specific embodiment thereof, and that such modifications or changes are intended to be encompassed within the scope of the appended claims. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms.

When a group of materials, compositions, components or compounds is disclosed herein, it is understood that all individual members of those groups and all subgroups thereof are disclosed separately. When a Markush group or other grouping is used herein, all individual members of the group and all combinations and subcombinations possible of the group are intended to be individually included in the disclosure. Every formulation or combination of components described or exemplified herein can be used to practice the invention, unless otherwise stated. Whenever a range is given in the specification, for example, a temperature range, a time range, or a composition range, all intermediate ranges and subranges, as well as all individual values included in the ranges given are intended to be included in the disclosure. In the disclosure and the claims, “and/or” means additionally or alternatively. Moreover, any use of a term in the singular also encompasses plural forms.

All references cited herein are hereby incorporated by reference in their entirety to the extent that there is no inconsistency with the disclosure of this specification. All headings used herein are for convenience only. All patents and publications mentioned in the specification are indicative of the levels of skill of those skilled in the art to which the invention pertains, and are herein incorporated by reference to the same extent as if each individual publication, patent or patent application was specifically and individually indicated to be incorporated by reference. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

1. An optical imaging system comprising:
a) an optical housing able to hold one or more optical lens systems, the optical housing having a front end able to receive light from an object and a back end;
b) a front objective lens system positioned within the optical housing able to form an aerial image of the object;
c) a rear focusing system positioned behind the front objective lens system, wherein the rear focusing system has a focal length and is positioned within the optical housing so as to be able to focus the aerial image and transmit an infinity beam to a rear imaging system; and
d) the rear imaging system positioned within the optical housing behind the rear focusing system, wherein the rear imaging system is able to focus the infinity beam onto a camera, sensor, further imaging system, or microscope device.

2. The optical imaging system of claim 1 further comprising a minifying lens system positioned between the front objective lens system and the rear focusing system, wherein the minifying lens system is able to produce a modified aerial image that is closer to the front objective lens system.

3. The optical imaging system of claim 2, where the modified aerial image is smaller than if the minifying lens was not used.

4. The optical imaging system of claim 1, wherein the rear focusing system comprises one or more moveable or deformable lens systems able to alter the focal length of the rear focusing system.

5. The optical imaging system of claim 1 further comprising a frontal corrector lens system positioned within the optical housing in front of the front objective lens system.

6. The optical imaging system of claim 5, wherein the frontal corrector lens system has a focal length of 100 mm or more and is able to decrease system distortion by c.5% or more.

7. The optical imaging system of claim 1, wherein the optical housing has a length of 200 mm or less.

8. The optical imaging system of claim 1, wherein the optical imaging system is able to be integrated with 23 mm, 24 mm and 35 mm cameras.

9. The optical imaging system of claim 1, wherein the optical imaging system is able to be integrated with cinematographic cameras.

10. A modular optical imaging system comprising:
a) an optical housing able to hold one or more optical lens systems, the optical housing having a front end able to attach to a front lens system having a front objective lens system, wherein the front objective lens system is able to form an aerial image of an object;
b) a rear focusing system positioned within the optical housing, wherein the rear focusing system has a focal length so as to be able to focus the aerial image when the optical housing is attached to the front lens system and transmit an infinity beam to a rear imaging system; and
d) the rear imaging system positioned within the optical housing behind the rear focusing system, wherein the rear imaging system is able to focus the infinity beam onto a camera, sensor, further imaging system, or microscope device.

11. The modular optical imaging system of claim 10 further comprising a minifying lens system positioned within the optical housing in front of the rear focusing system, wherein the minifying lens system is able to produce a modified aerial image in conjunction with the front objective lens system, where the modified aerial image is formed closer to the front end than the aerial image formed when the minifying lens is not used.

12. The optical imaging system of claim 10, where the modified aerial image is smaller than if the minifying lens was not used.

13. The modular optical imaging system of claim 10, wherein the rear focusing system comprises one or more moveable or deformable lens systems able to alter the focal length of the rear focusing system.

14. The modular optical imaging system of claim 10, wherein the rear focusing system comprises a first rear positive lens system, a second rear positive lens system, and a first rear negative lens system.

15. The modular optical imaging system of claim 10, wherein the modular optical imaging system is able to be integrated with 23 mm, 24 mm and 35 mm cameras.

16. The modular optical imaging system of claim 10, wherein the modular optical imaging system is able to be integrated with cinematographic cameras.

17. The modular optical imaging system of claim 10, wherein the camera, sensor, further imaging system, or microscope device is able to be interchanged with a different camera, sensor, further imaging system, or microscope device.

18. A modular optical imaging system comprising:
a) an optical housing able to hold one or more optical lens systems, the optical housing having a front end able to attach to a front lens system having a front objective lens system, wherein the front objective lens system is able to form an aerial image of an object;
b) a rear focusing system positioned within the optical housing, wherein the rear focusing system has a focal length so as to be able to focus the aerial image when the optical housing is attached to the front lens system and transmit an infinity beam to a rear imaging system;
d) the rear imaging system positioned within the optical housing behind the rear focusing system, wherein the rear imaging system is able to focus the infinity beam onto a camera, sensor, further imaging system, or microscope device; and
e) a minifying lens system positioned within the optical housing in front of the rear focusing system, wherein the minifying lens system is able to produce a modified aerial image in conjunction with the front objective lens system, where the modified aerial image is formed closer to the front end than the aerial image formed when the minifying lens is not used.
